(19) United States
(12) Patent Application Publication
(10) Pub. No.: US 2008/0241625 A1
(43) Pub. Date: Oct. 2, 2008

(54) Solid oxide fuel cell stack

(75) Inventor: Kosaku Fujinaga, Fukuoka (JP)

Correspondence Address: CARRIER BLACKMAN AND ASSOCIATES, 24101 NOVI ROAD, SUITE 100, NOVI, MI, 48375, US

(73) Assignee: Toto Ltd., Kitakyushu-shi (JP)

(21) Appl. No.: 12/079,946

(22) Filed: Mar. 28, 2008

(30) Foreign Application Priority Data
Mar. 30, 2007 (JP) 2007-095208

(51) Int. Cl. H01M 8/10

(52) U.S. Cl. 429/30

(57) ABSTRACT

A solid oxide fuel cell stack includes a plurality of fuel cells, each having a cylindrical shape, a conductive member via which the fuel cells are electrically coupled, and a holding member surrounding the fuel cells and the conductive member. The holding member includes a pressing portion which presses the fuel cells and the conductive member in an electrically serial direction, and a fixing portion which fixes the pressing portion such that the fuel cells and the conductive member are constantly pressed.

### CROSS-REFERENCE TO RELATED APPLICATION(S)

The present application claims priority from Japanese Patent Application No. 2007-095208 filed on Mar. 30, 2007, the entire content of which is incorporated herein by reference.

### FIELD OF THE INVENTION

The present invention relates to a structure of a solid oxide fuel cell stack in which a plurality of solid oxide fuel cells is electrically coupled to each other.

### DESCRIPTION OF THE RELATED ART

A solid oxide fuel cell is expected as a fuel cell having a high working temperature (about 700° C. to about 1000° C.) and a high efficiency. Usually, solid oxide fuel cells are electrically coupled in series and/or in parallel to form a stack, and are used in a form of a module structure in which fuel cell stacks are electrically coupled in series and/or in parallel. Hereinafter, a unit of one fuel cell will be described as “a fuel cell”, and a member which electrically couples the fuel cells will be described as “a conductive member”.

In a related-art fuel cell stack, a plurality of fuel cells is disposed and fixed to a conductive holding member having a U-shaped section in an electrically parallel unit, and fuel electrodes of adjacent fuel cells are electrically coupled in parallel via a nickel felt. A nickel felt is also provided on an interconnector of each of the fuel cells. Units of parallel fuel cells that are arranged on the respective holding member are stacked, whereby interconnectors and corresponding fuel electrodes of fuel cells disposed thereabove are electrically coupled in series respectively (see, e.g., JP 3281821 B2).

However, such a fuel cell stack structure requires a burning process in which a heat treatment is carried out at a predetermined temperature while setting an air electrode side into an oxidizing atmosphere and a fuel electrode side into a reducing atmosphere. Thus, there has been a problem in that an industrial mass production is difficult.

Furthermore, the fuel cells, and the fuel cell and the holding member are coupled to each other only via the nickel felts. Thus, there has been another problem in that the fuel cell and the nickel felt are likely to be separated from each other due to a shock during an assembly or a transportation of a fuel cell module.

In a fuel cell module according to another related art, a heat insulating material, an inner fuel cell container, another heat insulating material and an outer fuel cell container are arranged in this order around a plurality of fuel cell stacks, thereby keeping a current collection from fuel cells and conductive members of the plurality of fuel cell stacks while permitting a variation in a thermal stress which may be caused by a temperature distribution of the respective fuel cells before and after a power generation (see, e.g., JP 1-248479 A).

However, in such a fuel cell module structure, before and after the power generation, a thermal distortion is generated in the inner fuel cell container due to a difference in a temperature between a portion near the fuel cell stack and a portion near the inner fuel cell container because of the heat insulating material surrounding the fuel cell stacks, so that a gap is likely to be created between the inner fuel cell container and the heat insulating material near the inner fuel cell container. Moreover, a fuel gas having a higher density is supplied to a portion near the inner fuel cell container than a portion of the heat insulating material near the fuel cell stacks. Thus, there has been a problem in that an amount of the fuel gas which does not contribute to the power generation of the fuel cells is increased, resulting in a deterioration in the power generating performance of the fuel cells.

Furthermore, fuel cells sometimes have a warpage of about 2 mm per meter, and in such cases, a coupling failure between the fuel cell and the conductive member is likely to be generated due to an action of a thermal stress caused in each of the fuel cells in accordance with a temperature distribution of the fuel cells at the time of power generation. In order to prevent such a coupling failure, i.e., in order to maintain a stable coupling of the fuel cell and the conductive member, there has been a problem that a structure for pressing the fuel cell stacks at least in an electrically serial direction needs to be additionally provided, which makes the module structure complex.

### SUMMARY OF THE INVENTION

One or more exemplary embodiments of the present invention provide a fuel cell stack which is suitable for an industrial mass production by simplifying a manufacturing process.

Furthermore, one or more exemplary embodiments of the present invention provide a fuel cell stack in which a fuel gas is effectively supplied to a fuel cell to improve power generating performance.

According to one or more exemplary embodiments of the present invention, a solid oxide fuel cell stack includes a plurality of fuel cells, each having a cylindrical shape, a conductive member via which the fuel cells are electrically coupled, and a holding member surrounding the fuel cells and the conductive member. The holding member includes a pressing portion which presses the fuel cells and the conductive member in an electrically serial direction, and a fixing portion which fixes the pressing portion such that the fuel cells and the conductive member are constantly pressed.

Other aspects and advantages of the invention will be apparent from the following description, the drawings and the claims.

### BRIEF DESCRIPTION OF THE DRAWINGS

FIG. 1 is a perspective view showing a section of a solid oxide fuel cell according to an exemplary embodiment of the present invention;

FIG. 2 is a perspective view showing a structure of a fuel cell stack according to a first exemplary embodiment of the present invention;

FIG. 3 is a sectional view taken along a line III-III in FIG. 2;

FIG. 4 is an explanatory view showing an example of a structure of a connecting portion of a holding member;

FIG. 5 is an explanatory view showing an example of a fuel cell module having the fuel cell stack illustrated in FIG. 2;

FIG. 6 is a sectional view of a fuel cell stack according to a second exemplary embodiment of the present invention;

FIG. 7 is a perspective view of a fuel cell stack according to a third exemplary embodiment of the present invention;

FIG. 8 is a sectional view taken along the line VIII-VIII in FIG. 7;

FIG. 9 is a perspective view of a fuel cell stack according to a fourth exemplary embodiment of the present invention;

FIG. 10 is a sectional view taken along the line X-X in FIG. 9;

FIG. 11 is a sectional view taken along the line XI-XI in FIG. 9;

FIG. 12 is a sectional view taken along the line XII-XII in FIG. 9;

FIG. 13 is an explanatory view showing a current collecting structure of a fuel cell stack according to a fifth exemplary embodiment of the present invention;

FIG. 14 is a perspective view showing a section of a solid oxide fuel cell according to a sixth exemplary embodiment of the present invention; and

FIG. 15 is a sectional view of a portion of a fuel cell stack according to the sixth exemplary embodiment of the present invention.

### DETAILED DESCRIPTION OF EXEMPLARY EMBODIMENTS

Hereinafter, exemplary embodiments of the present invention will be explained with reference to the drawings. The following exemplary embodiments do not limit the scope of the present invention.

### FIRST EXEMPLARY EMBODIMENT

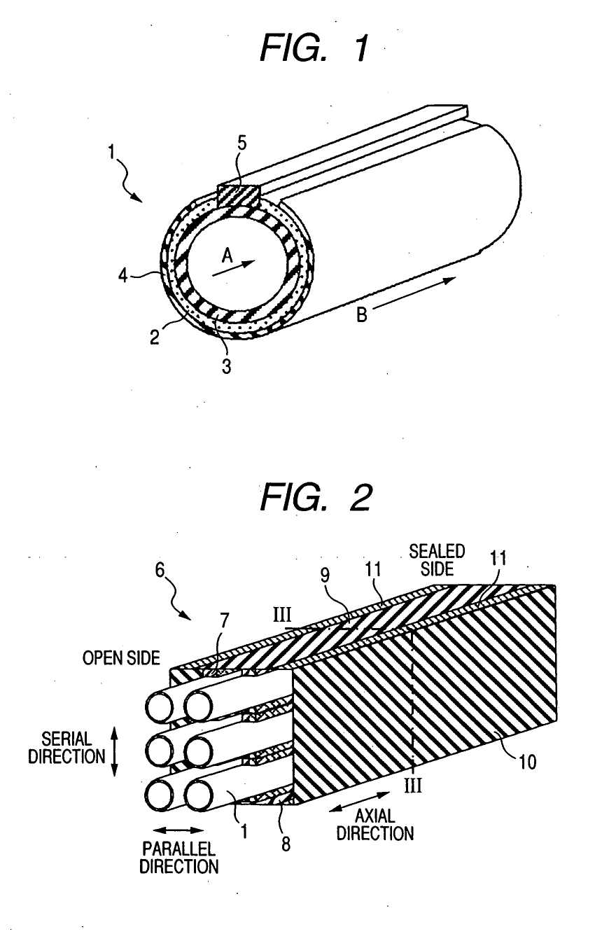

As shown in FIG. 1, a solid oxide fuel cell 1 (hereinafter, a fuel cell 1) has a cylindrical shape. The fuel cell 1 includes an electrolyte 2, an air electrode 3, a fuel electrode 4, and an interconnector 5 connected to the air electrode 3. According to this fuel cell 1, air containing oxygen is caused to flow in a direction passing through an inner part A of the air electrode 3, and a fuel gas containing hydrogen and/or carbon monoxide is caused to flow in a direction passing through an outer part B of the fuel electrode 4. Although the fuel cell 1 shown in FIG. 1 has a configuration in which the air electrode 3 is disposed on an inner side of the fuel electrode 4, the fuel cell 1 may have a configuration in which the air electrode 3 is disposed on an outer side of the fuel electrode 4.

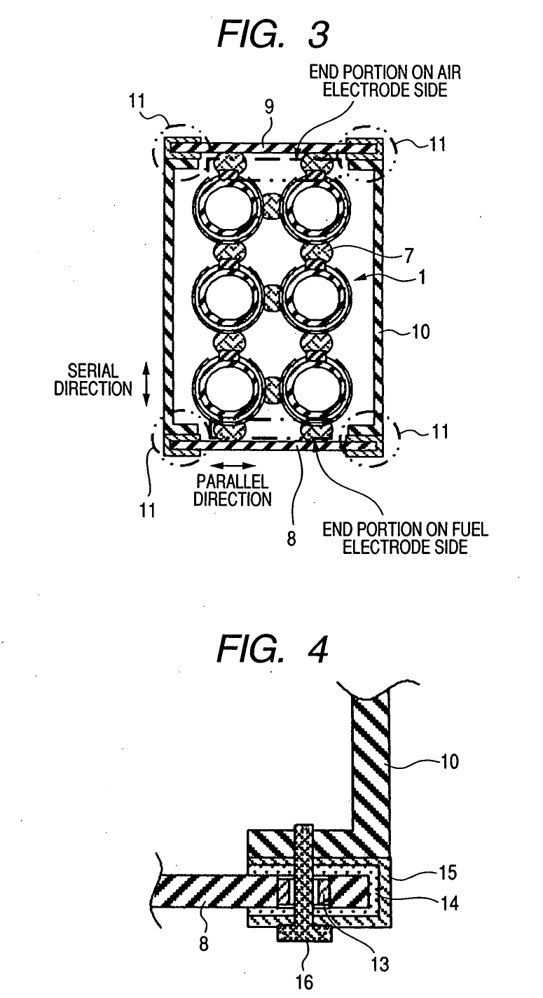

As shown in FIGS. 2 and 3, a fuel cell stack 6 includes a plurality of fuel cells 1 stacked in 2-parallel and 3-series configuration, and a holding member surrounding the fuel cells 1. The fuel cells 1 are electrically coupled in series and/or in parallel via conductive members 7 having a high elasticity and restoring capability. More specifically, the fuel cells 1 are coupled in series by coupling the fuel electrode 4 of one of the fuel cells 1 and the interconnector 5 of the other fuel cell 1, and the fuel cells 1 are coupled in parallel by coupling the fuel electrodes 4 of the respective fuel cells 1. Each of the conductive members 7 is, for example, a laminated metal sheet having a three-dimensional structure with a continuous column serving as a frame.

The holding member includes a fuel electrode side holding member 8 disposed on a fuel electrode side of the fuel cell stack 6, an air electrode side holding member 9 disposed on an air electrode side of the fuel cell stack 6, and side surface holding members 10 disposed so as to be parallel to a direction in which the fuel cells 1 are electrically coupled in series inside the fuel cell stack 6 (hereinafter, an electrically serial direction). The fuel electrode side holding member 8 and the air electrode side holding member 9 are coupled to the side surface holding members 10 via connecting portions 11, thereby pressing the fuel cells 1 and the conductive members 7 such that a coupling configuration of the fuel cells 1 and the conductive members 7 are maintained and such that the fuel cells 1 and the conductive members 7 are held over substantially the entire length thereof along an axial direction of the fuel cells 1. The fuel electrode side holding member 8 is electrically coupled to the fuel electrodes 4 of the fuel cells 1, and the air electrode side holding member 9 is electrically coupled to the air electrodes 3 of the other fuel cells 1. Each of the fuel electrode side holding member 8 and the air electrode side holding member 9 is electrically insulated from the side surface holding members 10 by the connecting portion 11. A generated power is output between the fuel electrode side holding member 8 and the air electrode side holding member 9, and can be fetched from the fuel electrode side holding member 8 and/or the air electrode side holding member 9.

According to the configuration described above, the fuel cells 1 and the conductor members 7 of the fuel cell stack 6 are pressed irrespective of before or after the power generation, without carrying out a burning process. Therefore, it is possible to ensure an excellent electrical connection without pressing the fuel cell module in the electrically serial direction during the power generation. Furthermore, the stack structure can be maintained stable during a handling of the fuel cell stack 6 such as an assembly or transportation of the fuel cell module.

Because the fuel electrode side holding member 8 and the air electrode side holding member 9 are electrically insulated from the side surface holding members 10 respectively, even if the adjacent side surface holding members 10 come in contact with each other due to thermal deformation during the power generation, the fuel cells 1 can be prevented from causing a deterioration resulting from a short circuit such as a generation of an excessive thermal stress caused by a local heat generation or a change in a property of a base material of the fuel cells 1 caused by a reverse reaction to a power generating reaction. Thus, it is possible to maintain the stable electrical connection of the fuel cell stack 6 and to suppress a deterioration of the fuel cell stack 6 such as performance degradation or a breakage. Accordingly, it is possible to provide the fuel cell stack 6 having a high reliability. Furthermore, there is also an advantage that it is possible to connect the holding members surrounding each of the fuel cell stacks 6 by means of screw fixation, welding or riveting, thereby easily carrying out the current collection of the fuel cell stacks 6. The holding member may be formed of a ceramic or a refractory metal such as heat-resistant stainless steel or Inconel, and the conductive member 7 may be formed from a metallic porous body or a metal plate formed of a metallic material containing nickel as a main component. In a case in which the holding member is formed of a ceramic, it is necessary to provide stack current collectors in order to fetch a power to terminals on respective sides of the fuel cell stack 6. The fuel cell stacks 6 are electrically coupled to each other through such stack current collectors.

FIG. 4 is an explanatory view showing an example of a structure of the connecting portion 11. As shown in FIG. 4, the connecting portion 11 has an insulating ring 13 disposed on an inner side of a hole provided in a part of the fuel electrode side holding member 8. A ceramic fiber sheet 14 is formed therearound, and via a holding plate 15 maintaining a shape of the ceramic fiber sheet 14, the fuel electrode side holding member 8 and the side surface holding member 10 are coupled by means of a coupling fitting 16 without an electrical conduction therebetween. As a result, even if the holding member expands or contracts due a change in a temperature during the power generation, a stress applied from the fuel electrode side holding member 8 and the side surface holding member 10 to the connecting portion 11 can be controlled by dispersing the stress at the coupling fitting 15 through the ceramic fiber sheet 14 having a buffering property. Therefore, it is possible to suppress a deterioration of the connecting portion 11 such as a deformation or breakage, thereby maintaining an insulating structure. The insulating ring 13 and the ceramic fiber sheet 14 may be formed of alumina, mullite, magnesia or zirconia.

It is preferable that the coupling fitting 16 be attached so as to press the fuel cell stack 6 in a direction parallel to the electrically serial direction of the fuel cell stack. As a result, when handling the fuel cell stack 6 such as assembling or transporting or during the power generation in which causes a thermal stress distribution is generated due to a change in a temperature, a stress acting on coupling surfaces between the fuel cells 1 and the conductive members 7 in the fuel cell stack 6 is always concentrated only in directions parallel to the electrically serial direction, so that a generation of a stress in an electrically parallel direction can be suppressed. Accordingly, even if an internal stress acts on the fuel cell stack 6 due to an external stress caused by the handling of the fuel cell stack 6 or a thermal stress generated by the temperature distribution, the internal stress of the fuel cell stack 6 is not dispersed to the coupling structure of the fuel cells 1 and the conductive members 7 such that the stress in the electrically parallel direction is increased. Thus, it is possible to stably maintain the electrical coupling of the fuel cells 1 and the conductive members 7.

It is preferable that the holding member be provided over substantially the entire length of the fuel cells 1 in the axial direction. According to such a configuration, when handling the fuel cell stack 6 such as assembling or transporting or during the power generation in which the thermal stress distribution is caused by the change in a temperature, a compression force applied to the fuel cells 1 through the conductive members 7 can be dispersed in the axial direction of the fuel cells 1, thereby preventing a local stress from being generated so that the breakage of the fuel cells 1 can be suppressed. Thus, it is possible to stably maintain the coupling of the fuel cells 1 and the conductive members 7. Moreover, it is possible to fetch the generated power from any portions in the axial direction of the fuel cells 1. For example, the temperature of the fuel cells 1 can be controlled such that a current collecting resistance of the stack current collector is increased in a portion in the axial direction of the fuel cell stack 6 where a temperature is high so that a power generating reaction is suppressed, and such that the current collecting resistance in a portion where a temperature is low is reduced so that the power generating reaction is facilitated. Accordingly, a distribution of a current density in the axial direction of the fuel cells 1 is made uniform so that it is possible to form a structure in which a variation in the power generating temperature of the fuel cells 1 is small and a drift of a fuel gas is suppressed.

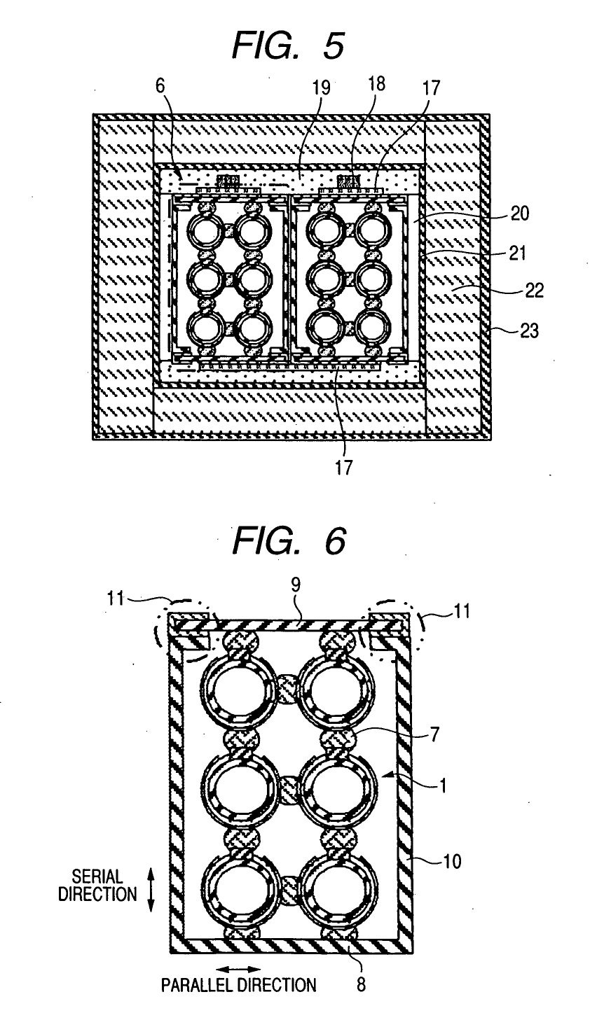

FIG. 5 is an explanatory view for explaining an example of a fuel cell module comprising the fuel cell stack 6 shown in FIG. 2. As shown in FIG. 5, the fuel cell stacks 6 are electrically coupled to each other via a stack current collector 17 between the fuel electrode side holding members 8 and/or the air electrode side holding members 9, and the stack current collector 17 coupled to the air electrode side and the stack current collector 17 coupled to the fuel electrode side are electrically coupled to respective current collecting rods 18. The fuel cell stacks 6 are held on an inner side of an inner fuel cell container 21, which is for maintaining an airtightness of a fuel gas, such that an insulating-buffering member 19 is disposed between the inner fuel cell container 21 and the fuel electrode side holding member 8 and/or the air electrode side holding member 9. Furthermore, a heat insulating material 22 and an outer fuel cell container 23 are formed on an outer side of the inner fuel cell container 21 in this order. According to such a configuration of the fuel cell module, the fuel cells 1 and the conductive members 7 are held and fixed in units of the fuel cell stacks 6, whereby a stable stack structure is maintained without conducting the fuel cell stacks 6 and the inner fuel cell container 21. In other words, by providing the insulating-buffering material for gas sealing and filling a gap, the structure of the fuel cell module can be maintained stable without a need of pressing the fuel cell stacks 6 by providing a voluminous heat insulating material, which has a hardness required for pressing, around the fuel cell stacks 6. As a result, it is possible to provide a downsized configuration of the fuel cell module by placing the insulating-buffering material as the heat insulating material in a power generating chamber inside the inner fuel cell container. Moreover, a temperature gradient of the supplied fuel gas, which may be caused by the heat insulating material, becomes less likely to be generated. Therefore, it is possible to supply, to the fuel cells 1, the fuel gas having a small density difference, thereby suppressing the drift of the fuel gas inside the power generating chamber. Accordingly, a fuel gas contributing to the power generation of the fuel cell stacks is increased, so that a downsized and high performance fuel cells can be provided.

### SECOND EXEMPLARY EMBODIMENT

FIG. 6 is a sectional view of a fuel cell stack according to a second exemplary embodiment of the present invention. As shown in FIG. 6, a holding member surrounding fuel cells 1 and conductive members 7 includes a fuel electrode side holding member 8, an air electrode side holding member 9 and side surface holding members 10 in a similar manner as in the first exemplary embodiment, however, the fuel electrode side holding member 8 and the side surface holding members 10 are formed in a one-piece structure. The fuel cells 1 and the conductive members 7 are pressed by the fuel electrode side holding member 8 and the air electrode side holding member 9, and the side surface holding members 10 are coupled and fixed to the air electrode side holding member 9 via connecting portions 11 while keeping the pressing state. The fuel electrode side holding member 8 is electrically coupled to a fuel electrode side of the fuel cells 1, and the air electrode side holding member 9 is electrically coupled to an air electrode side of the fuel cells 1. The one-piece structure, including the fuel electrode side holding member 8 and the side surface holding members 10, and the air electrode side holding member 9 are electrically insulated from each other by the connecting portions 11.

According to the configuration described above, because the fuel electrode side holding member 8 and the side surface holding members 10 are formed as the one-piece structure, it is possible to abolish a step of assembling the fuel electrode side holding member 8 and the side surface holding members 10, thereby allowing an easier assembling work of fuel cell stack 6. Moreover, a variation in shapes of the fuel cell stacks 6 through the assembly of the fuel electrode side holding member 8 and the side surface holding members 10 is relieved, whereby the holding member can be accurately configured such that the side surface holding members 10, which are parallel to the electrically serial direction, and the fuel electrode side holding member 8, which is perpendicular to the electrically serial direction, form right angles to each other. Accordingly, it is possible to assemble the fuel cell stack 6 with high precision based on the holding member.

### THIRD EXEMPLARY EMBODIMENT

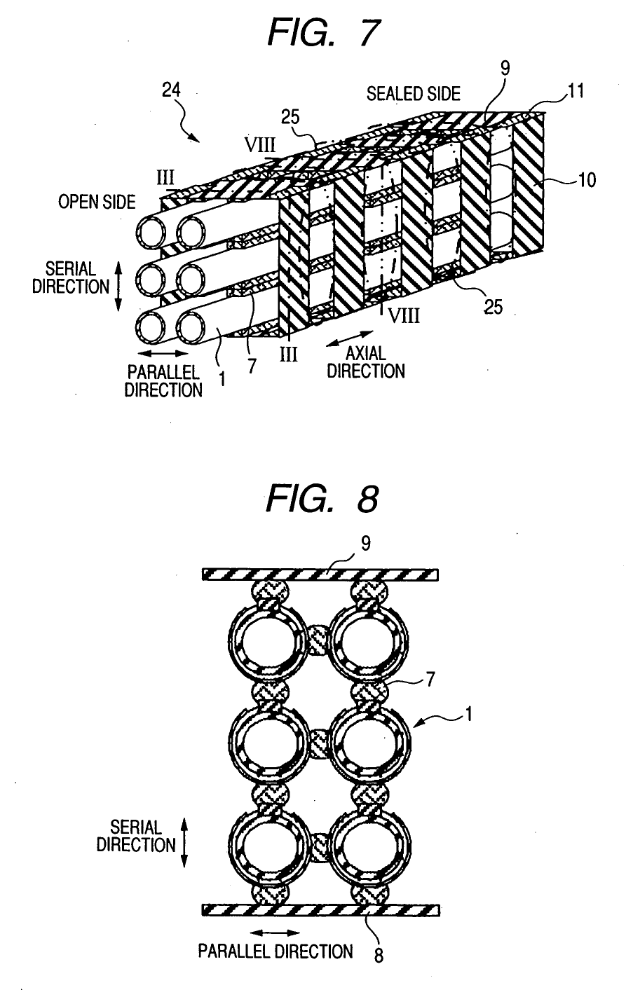

FIG. 7 is a perspective view of a fuel cell stack 24 according to a third exemplary embodiment of the present invention, and FIG. 8 is a sectional view taken along the line VIII-VIII in FIG. 7. Moreover, the sectional view taken along the line III-III in FIG. 7 is similar to FIG. 3.

As shown in FIGS. 7 and 8, the fuel cell stack 24 includes stacked fuel cells 1, conductive members 7 coupling the respective fuel cells 1, and a holding member surrounding the fuel cells 1 and the conductive members 7. The holding member includes a fuel electrode side holding member 8, an air electrode side holding member 9 and side surface holding members 10. Each of the side surface holding members 10 has exposing portions 25 which are formed at an interval in an axial direction of the fuel cells 1.

According to the configuration described above, the holding member can absorb and radiate heat through each of the exposing portions 25, thereby preventing an accumulation of a great thermal distortion which may be caused by a difference in a linear expansion coefficient between the fuel cells 1 and the holding member in the axial direction of the fuel cells 1 or a difference in the linear expansion coefficient of the holding member due to a temperature distribution. Moreover, there is another advantage that a fuel gas surrounding surfaces of the fuel cells 1 and the holding member is diffused in the exposed portions so that a gas density and a gas temperature can be made uniform. Accordingly, the holding member can maintain its structure depending on a temperature distribution generated in the axial direction of the fuel cells 1 so that a contact of the fuel cells 1 and the conductive members 7 can be maintained stable, whereby the fuel cell stack 24 can obtain a power generating performance which is safe and highly efficient. In view of suppressing the distortion of the holding member, it is preferable to form the holding member such that a difference in the linear expansion coefficient caused by a temperature distribution is less than about 2×10⁻⁶ (cm/cm·K⁻¹) in the same material. Further, because the conductive members 7 coupling the fuel cells 1 to each other are exposed similarly in the axial direction of the fuel cells 1, it is possible to absorb and radiate heat generated on respective connecting surfaces of the fuel cells 1 and the conductive members 7 through the surfaces of the fuel cells 1 and the exposed conductive members 7, thereby preventing an accumulation of a great thermal distortion due to a difference in a linear expansion coefficient between the fuel cells 1 and the conductive members 7 in the axial direction of the fuel cells 1 or a difference in a linear expansion coefficient of the conductive members 7 due to a temperature distribution. Moreover, there is another advantage that the fuel gas surrounding the surfaces of the fuel cells 1 and the conductive members 7 is diffused in the exposed portions, so that the gas density and the gas temperature can be made uniform, and furthermore, a flow rate per unit time of the fuel gas is reduced to increase the fuel gas contributing to the power generation of the fuel cells 1, resulting in an improvement in the power generating performance of the fuel cell stack 24. Accordingly, the fuel cell stack 24 can maintain its structure depending on the temperature distribution generated in the axial direction of the fuel cells 1, and can suppress a breakage of the fuel cells 1 due to a thermal stress, thereby keeping the electrical couplings of the fuel cells 1 and the conductive members 7 stable. Thus, it is possible to provide the fuel cell stack 24 having the power generating performance which is safe and highly efficient.

### FOURTH EXEMPLARY EMBODIMENT

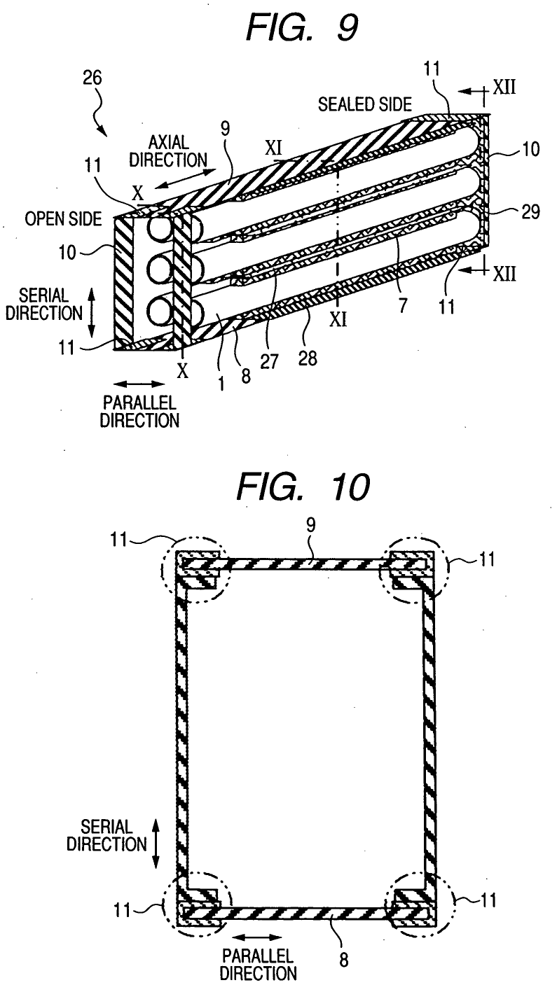

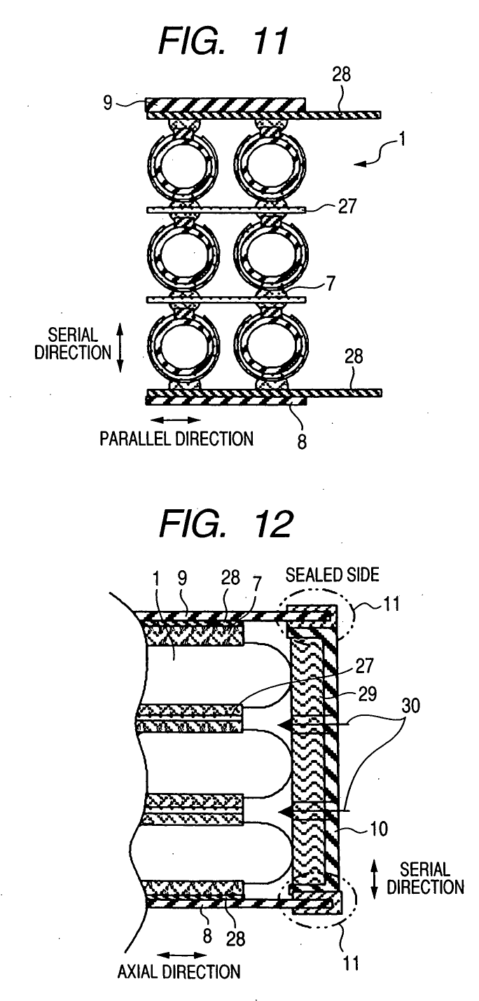

FIG. 9 is a perspective view of a fuel cell stack 26 according to a fourth exemplary embodiment of the present invention, and FIGS. 10, 11 and 12 are sectional views taken along the lines X-X, XI-XI and XII-XII in FIG. 9, respectively.

As shown in FIGS. 9 to 12, the fuel cell stack 26 includes stack of fuel cells 1, conductive members 7 coupling the respective fuel cells 1, and a holding member for pressing and holding the fuel cells 1 and the conductive members 7. The holding member includes a fuel electrode side holding member 8, an air electrode side holding member 9 and side surface holding members 10. The side surface holding members 10 are provided only on respective end sides in an axial direction of the fuel cells 1, namely, excluding a portion where the electrodes of the fuel cell 1 are disposed to generate power.

As shown in FIG. 12, on a sealed side, the fuel cells 1 are arranged with reference to a sealing portion buffering member 29 having vent holes 30. The fuel cells 1 are electrically coupled in series via the conductive members 7, and are electrically coupled in parallel via cell current collectors 27. More specifically, a fuel electrode 4 and an interconnector 5 are coupled to each other and/or the fuel electrodes 4 are coupled to each other. The fuel cells 1 and the conductive members 7 are pressed by the fuel electrode side holding member 8 and the air electrode side holding member 9 such that a shape of the fuel cell stack 26 is kept. As shown in FIG. 10, the fuel electrode side holding member 8 and the air electrode side holding member 9 are coupled and fixed to each other via the side surface holding members 10 and connecting portions 11 which are disposed only on the end portions in the axial direction of the fuel cells 1.

According to the configuration described above, the side surface holding members 10 are not provided in a power generation reacting portion of the fuel cells 1. Therefore, even if the side surface holding members 10 are deformed by the thermal stress so that the adjacent side surface holding members 10 come in contact with each other during the power generation of the fuel cell stack 26, it is possible to prevent a deterioration of the fuel cell 1, such as the generation of an excessive thermal stress due to a local heat generation or a change in a property of a base material of the fuel cell 1 due to a reverse reaction to a power generating reaction, which may be caused by a short circuit, without a direct contact to the fuel cells 1. Moreover, the fuel cell stacks 26 can be coupled to each other via a stack current collector 28 at a short distance without a detour, whereby a configuration with a small current collecting loss can be provided. Furthermore, because the side surface holding members 10 are provided only on an open side and the sealed side of the fuel cell stack 26, it is possible to freely set a pitch of the fuel cells 1 in the parallel direction, and to form a structure in which heat to be applied from the fuel cells 1 to the surrounding gas through the power generating reaction is maintained to be uniform, a variation in a power generating temperature of the fuel cells 1 is lessened, and a drift of the fuel gas is easily controlled. Accordingly, it is possible to maintain a stable electrical coupling of the fuel cell stacks 26, and to suppress a deterioration of the fuel cell 1, such as a reduction in the performance or a breakage. Thus, it is possible to provide the fuel cell stack 26 having a high reliability.

### FIFTH EXEMPLARY EMBODIMENT

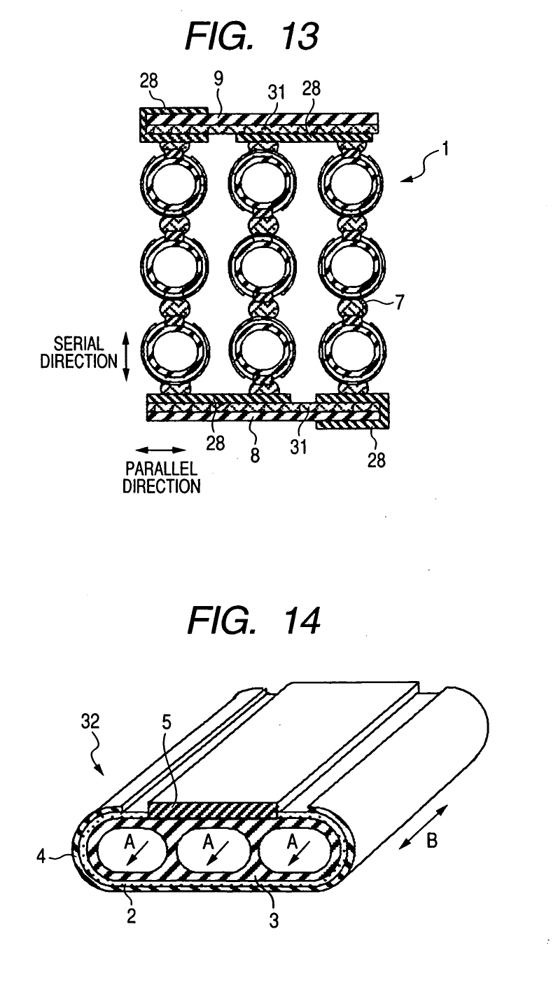

FIG. 13 is a sectional view showing a current collecting structure of a fuel cell stack according to a fifth exemplary embodiment of the present invention.

As shown in FIG. 13, fuel cells 1 are coupled to stack current collectors 28 in 3-serial units, and the fuel cells 1 thus stacked in 1-parallel and 9-series are surrounded by an insulating member 31, a fuel electrode side holding member 8 and an air electrode side holding member 9. All of the fuel cells 1 are electrically coupled in series via conductive members 7 and the stack current collectors 28. More specifically, a fuel electrode 4 of one of the fuel cells 1 is coupled to an interconnector 5 of the other of fuel cells 1.

According to the configuration described above, an electrode of the fuel cells 1 is reversed at the stack current collectors 28 disposed on respective ends in the electrically serial direction of the fuel cell stack, and the fuel cells 1 in series and/or in parallel, so that an electricity can be fetched from both ends or one of the ends of the fuel cell stack. Accordingly, it is possible to provide a fuel cell stack having versatilities with respect to specifications such as a shape of a power generating device, a current and a voltage. Further, by keeping a coupling distance in the electrically serial and parallel directions of the fuel cells 1 to be uniform, a uniform amount of heat is given from the fuel cells 1 to a fuel gas flowing inside the fuel cell stack, thereby relieving a temperature distribution in an axial direction of the fuel cells 1 or in a planar direction perpendicular thereto to prevent the fuel gas from flowing with a bias into the fuel cell stack. Accordingly, it is possible to provide a fuel cell stack having a highly efficient power generating performance.

It is preferable that a linear expansion coefficient of the holding member disposed around the fuel cells 1 be almost equal to a linear expansion coefficient of the fuel cells 1. For example, in a case in which the linear expansion coefficient of the fuel cells 1 is about 10.5×10⁻⁶ (cm/cm·K⁻¹), the linear expansion coefficient of the holding member may be about 7×10⁻⁶ (cm/cm·K⁻¹) to 14×10⁻⁶ (cm/cm·K⁻¹). As a result, a stress to the fuel cells 1 in a compressing direction and a stress to side surface holding members 10 in a pulling direction can be respectively transmitted by only depending on the thermal expansion of the conductive members 7, almost without being affected by the thermal expansion caused by the temperature distribution of the fuel electrode side holding member 8 and/or the air electrode side holding member 9 which is/are disposed in the fuel stack. Therefore, it is possible to easily provide a stable fuel cell stack structure in which an excellent contact of the fuel cells 1 and the conductive members 7 are maintained and a deformation of the side surface holding members 10 is permitted.

In the fuel cell stack according to the fifth exemplary embodiment, it is preferable that the holding member be formed by ferrite based stainless steel containing aluminum and/or molybdenum. As a result, it is possible to form a stable passive film such as chromia or alumina on a surface of the holding member, thereby preventing a deterioration such as an oxidation or a corrosion of the surface of the holding member in a reducing atmosphere containing carbon hydride such as hydrogen or methane, or hydrogen steam. Moreover, it is possible to prevent a defect such as a crack on the surface of the holding member by suppressing an amount of a deformation of heat resisting steel at a high temperature (about 700° C. to about 1000° C.). Thus, it is possible to keep the fuel cell stack structure stable.

### SIXTH EXEMPLARY EMBODIMENT

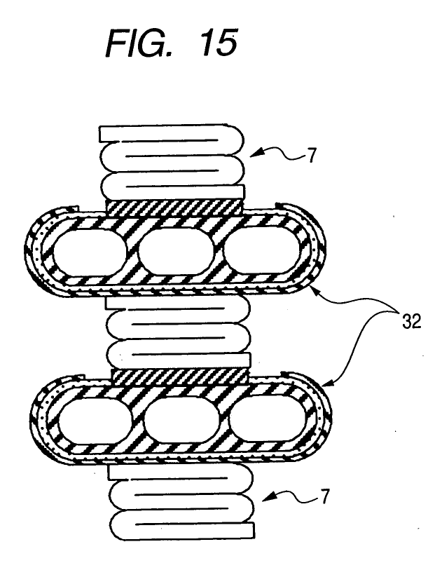

FIG. 14 is a perspective view showing a section of a solid oxide fuel cell 32 according to a sixth exemplary embodiment of the present invention. As shown in FIG. 14, the fuel cell 32 includes an electrolyte 2, an air electrode 3, a fuel electrode 4, and an interconnector 5 coupled to the air electrode 3. The air electrode 3 has at least two cylindrical spaces, and air containing oxygen is caused to flow in a direction passing through inner parts A thereof A fuel gas containing hydrogen and/or carbon monoxide is caused to flow in a direction passing through an outer part B of the fuel electrode 4. Also in a case in which the fuel cell 32 having the above-described configuration is used, it is possible to configure the fuel cell stacks of the first to fifth exemplary embodiments by coupling the fuel cells 32 via conductive members 7 as shown in FIG. 15.

Furthermore, the fuel cell stacks can also have such a configuration that the fuel gas flows through the inner side of fuel cells 1, 32 while an oxidant gas flows through the outer side of the fuel cells 1, 32 by using a material such as indium oxide for the conductive members 7.

Moreover, it is also possible to configure the fuel cell module shown in FIG. 5 with the fuel cell stacks of the second to fifth exemplary embodiments.

According to one or more exemplary embodiments of the present invention, it is possible to maintain the shape of the stack before and after the power generation in units of fuel cell stacks. Moreover, it is possible to provide a stack structure capable of eliminating a complicated burning process of the fuel cell stack. Furthermore, it is possible to eliminate a variation in a temperature distribution near the fuel cell container of the fuel cell module during the power generation, thereby enhancing the power generating performance of the fuel cell module. Accordingly, it is possible to provide a safe and highly efficient fuel cell stack which is practical and is excellent in a mass-producing property.

While description has been made in connection with exemplary embodiments of the present invention, those skilled in the art will understand that various changes and modification may be made therein without departing from the present invention. For example, numerical values in the above description of the exemplary embodiments may, of course, be set to different values as is advantageous. It is aimed, therefore, to cover in the appended claims all such changes and modifications falling within the true spirit and scope of the present invention.

What is claimed is:

1. A solid oxide fuel cell stack comprising:
a plurality of fuel cells, each having a cylindrical shape;
a conductive member via which the fuel cells are electrically coupled; and
a holding member surrounding the fuel cells and the conductive member,
wherein the holding member comprises a pressing portion which presses the fuel cells and the conductive member in an electrically serial direction, and a fixing portion which fixes the pressing portion such that the fuel cells and the conductive member are constantly pressed.

2. The solid oxide fuel cell stack according to claim 1, wherein each of the fuel cells comprises a fuel electrode and an air electrode,
the pressing portion comprises a fuel electrode side holding member which is electrically coupled to the fuel electrode of at least one of the fuel cells, and an air electrode side holding member which is electrically coupled to the air electrode of at least one of the other fuel cells, and
the fixing portion comprises a side surface holding member coupling the fuel electrode side holding member and the air electrode side holding member.

3. The solid oxide fuel cell stack according to claim 2, wherein the holding member further comprises an insulating portion which electrically insulates at least one of the fuel electrode side holding member and the air electrode side holding member from the side surface holding member.

4. The solid oxide fuel cell stack according to claim 2, wherein the side surface holding member and one of the fuel electrode side holding member and the air electrode side holding member are formed in a one-piece structure.

5. The solid oxide fuel cell stack according to claim 1, wherein the fixing portion is parallel to the electrically serial direction.

6. The solid oxide fuel cell stack according to claim 1, wherein the holding member extends over substantially the entire length of the fuel cells along an axial direction of the fuel cells.

7. The solid oxide fuel cell stack according to claim 2, wherein the side surface holding member comprising an exposing portion through which at least a portion of the fuel cells is exposed.

8. The solid oxide fuel cell stack according to claim 2, wherein the side surface holding member is disposed only on respective ends of the fuel cells in an axial direction of the fuel cells.

9. The solid oxide fuel cell stack according to claim 2, further comprising:
a current collector electrically coupled to the fuel cells; and
an insulating member disposed between the current collector and one of the fuel electrode side holding member and the air electrode side holding member.

10. The solid oxide fuel cell stack according to claim 2, wherein one of the fuel electrode and the air electrode has a plurality of cylindrical spaces therein.
